(19) United States
(12) Patent Application Publication
(10) Pub. No.: US 2015/0143113 A1
(43) Pub. Date: May 21, 2015

(54) METHOD AND SYSTEM FOR ENCRYPTING INFORMATION UTILIZING THREE-DIMENSIONAL SHAPES

(71) Applicant: ConnectX, Inc., Los Angeles, CA (US)

(72) Inventors: Lansing Arthur Parker, II, Los Angeles, CA (US); Solomon Golomb, La Canada, CA (US); Aaron Lauda, Glendale, CA (US)

(73) Assignee: CONNECTX, INC., Los Angeles, CA (US)

(21) Appl. No.: 14/516,515

(22) Filed: Oct. 16, 2014

Related U.S. Application Data
(60) Provisional application No. 61/891,535, filed on Oct. 16, 2013.

(51) Int. Cl. H04L 29/06

(52) U.S. Cl. CPC H04L 63/045
USPC 713/165

(57) ABSTRACT

Method and system is disclosed for encrypting information utilizing three-dimensional shapes. The method includes receiving one or more computer device usage metrics, one or more user files having information, and instructions for encrypting the one or more user files, selecting shape type from a plurality of predetermined shape types, determining shape dimensions and shape volume based upon quantity of information associated with the one or more user files, generating a shape based upon the selected shape type, the shape dimensions, and the shape volume, distributing axis coordinates for each axis, wherein a node is define at least by axis coordinates within the generated shape, associating information of the one or more user files with axis coordinates within the generated shape, and transmitting generated shape and data based upon the associating.

### CROSS REFERENCE TO RELATED APPLICATIONS

This application claims the benefit of U.S. Provisional Application Nos. 61/891,535 filed on Oct. 16, 2013 which is hereby incorporated herein by reference.

### TECHNICAL FIELD

This disclosure relates to data transmission, and more particularly to encryption schemes.

### BACKGROUND

The statements in this section merely provide background information related to the present disclosure and may not constitute prior art.

Encryption is the process of encoding data to prevent unauthorized parties from viewing or modifying it. Encryption prevents unwanted access to documents and e-mail messages. Strong levels of encryption are very difficult to break. Encryption can protect your data from unintended recipients or unscrupulous interceptors. Once the domain of spies, encryption is now an advisable precaution or requirement for businesses and home users.

Whether your encryption program is stand-alone or built into your e-mail app, the encryption process is the same: data passes through an algorithm, converting a message into encrypted data called ciphertext. These formulas require a key—which makes it difficult, for an unscrupulous entity or unintended recipient to crack the encryption and read the data.

There are two types of encryption: symmetric and asymmetric (also called public key). With symmetric encryption, you run a file through the program and create a key that scrambles the file. Then you e-mail the encrypted file to the recipient and separately transmit the decoding key (which could be a password or another data file). Running the same encryption application, the recipient uses the decoding key to unscramble the message. Symmetric encryption is fast but not as safe as asymmetric encryption because someone could intercept the key and decode the messages. But because of its speed, it's commonly used for e-commerce transactions.

Asymmetric encryption is more complex—and more secure. Two related keys are required: a public key and a private key. You make your public key available to anyone who might send you encrypted information. That key can only encode data; it cannot decode it. Your private key stays safe with you. When people wish to send you encrypted information, they encrypt it using your public key. When you receive the ciphertext, you decrypt it with your private key. Asymmetric encryption's added safety comes at a price: More computation is required, so the process takes longer.

Symmetric and asymmetric encryption use different algorithms to produce ciphertext. In symmetric encryption, the algorithm divvies up data into small chunks called blocks. It then switches letters around, changes the information in each block into numbers, compresses and expands the data, and runs those numbers through mathematical formulas that include the key. Then the algorithm repeats the process, sometimes dozens of times over. An asymmetric encryption's algorithm, on the other hand, treats the text as though it were a very large number, raises it to the power of another very large number, and then calculates the remainder after dividing it with a third very large number. Finally, the remainder number is converted back into text. Encryption programs can use the same algorithms differently, which is why the recipient needs to use the same application to decode the message that you used to encode it.

Keys are the final piece in the encryption puzzle. Keys vary in length and, consequently, in strength. The reason: The longer the key, the greater the number of possible combinations. For example, if your encryption program uses 128-bit keys, your particular key could be any of more than 3.4 trillion billion billion billion—or 2 to the power of 128—possible combinations of zeros and ones. A hacker is more likely to win the lottery than to crack that level of encryption using the brute-force method (systematically trying key combinations until they find the right one). By comparison, encryption experts can crack the average 40-bit symmetric key in about six hours on a typical home PC using brute force. However, even 128-bit encryption is vulnerable to some extent; pros have some sophisticated techniques that can help them crack even the toughest codes. Hence, it would be advantageous to provide or supplement known encryption schemes with an alternative scheme based upon geometric shapes.

### SUMMARY

Method and system is disclosed for encrypting information utilizing three-dimensional shapes. The method includes receiving one or more computer device usage metrics, one or more user files having information, and instructions for encrypting the one or more user files, selecting shape type from a plurality of predetermined shape types, determining shape dimensions and shape volume based upon quantity of information associated with the one or more user files, generating a shape based upon the selected shape type, the shape dimensions, and the shape volume, distributing axis coordinates for each axis, wherein a node is define at least by axis coordinates within the generated shape, associating information of the one or more user files with axis coordinates within the generated shape, and transmitting generated shape and data based upon the associating.

Certain embodiments of the invention include a feature of placing groups of data in space of a 3-dimensional geometric shape. The system can use simple shapes like a shape or complicated shapes like a double tetrahedron, platonic solid or even a 3-dimensional flower of life shape found in sacred geometry, any shape can be used.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows . . . , in accordance with the present disclosure; and

FIG. 2 shows an overview flowchart illustrating a process for encrypting user data, in accordance with the present disclosure;

FIG. 3 shows an exemplary generated shape having dimensions, in accordance with the present disclosure;

FIG. 4 shown an exemplary generated shape having defined Cartesian coordinates, in accordance with the present disclosure;

FIG. 5 shows an exemplary generated shape having defined nodes, in accordance with the present disclosure;

FIG. 6 shows an exemplary process for encrypting information utilizing generated three-dimensional shapes, in accordance with the present disclosure;

FIG. 7 shows an exemplary shape having exemplary randomly distributed coordinates, in accordance with the present disclosure;

FIG. 8 shows an exemplary embodiment of groups of information associated with nodes within the shape, in accordance with the present disclosure; and

FIG. 9 shows an exemplary shape having information associated with nodes within the shape including a null node, in accordance with the present disclosure.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

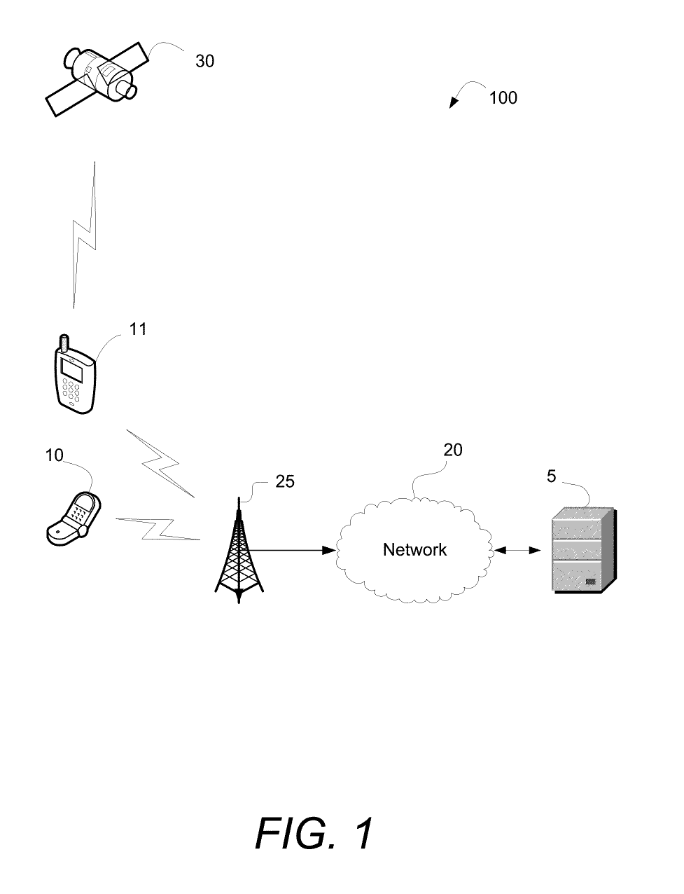

Referring now to the drawings, wherein the depictions are for the purpose of illustrating certain exemplary embodiments only and not for the purpose of limiting the same, FIG. 1 is a block diagram of an exemplary communication system 100 including one or more computing devices 5, a plurality of mobile devices 10, a network 20, a radio communication tower 25, and communication satellite 30 that have been constructed in accordance with an embodiment of the disclosure. As shown in FIG. 1, the computing device 5 may be directly communicatively connected and communicatively connected via the network 20. The device 10 is connected to the network 20 via the radio communication tower 25. Components of the communication system 100 are shown in FIG. 1 as single elements. Such illustration is for ease of description and it should be recognized that the communication system 100 may include multiple additional implementations of the components, e.g., a device may be physically connected to the network 20 during selected periods of operation. In embodiments described herein below the device is connected to the network 20 via the communication satellite 30. The device 10 may be any device configured to execute computing functions and access the distributed computing environment as described herein below such as a mobile phone, desktop computer, or other computing device.

The network 20 is a series of points or nodes interconnected by communication paths and may be interconnected with other networks and contain sub networks. The most common topologies or general configurations of networks include bus, star and ring topologies. Networks can also be characterized in terms of spatial distance as local area networks (LANs), metropolitan area networks (MANs) and wide area networks (WANs). Various parts of the communication system 100 may be implemented by mobile components and may not be permanently attached to the network 20. For example, entities may interact with each other via a wireless connection using mobile components including components utilizing the radio communication towers 25. Embodiments of the present disclosure are usable with a number of networks, such as the global internetwork of networks referred to as the “Internet” and its variants (e.g., intranets, virtual nets, overlay networks and the like). Although the Internet will be used as the primary example in this disclosure, the disclosure herein may be used with other systems also including a private network, for example some point-of-sale (“POS”) systems or in store retail systems, and therefore is not limited thereby.

The computing device 5 may be one of more embodiments of a computer including high-speed microcomputers, minicomputers or mainframes. The computing device 5 may be configured to execute database functions including storing and maintaining a database and processes requests from the device 10.

The device 10 may be any type of communications or mobile computing device including e.g., a cellular phone, digital media player (e.g., audio or audio/video), personal digital assistant (“PDA”) and a smart phone, which is a combination mobile telephone and handheld computer having PDA functionality. PDA functionality can comprise one or more of personal information management, database functions, word processing, spreadsheets, voice memo recording, location-based services, device backup and lock, media playing, Internet browsing, etc. and is configured to synchronize, publish/subscribe, download, or otherwise communicate personal information or user data (e.g., contacts, e-mail, calendar, notes, to-do list, web browser favorites, etc.) from one or more applications with a computer (e.g., desktop, laptop, server, etc.). Device 10 is further configured to receive and operate additional applications provided to device 10 after manufacture, e.g., via wired or wireless download. A second device 11 is shown in FIG. 1 to illustrate satellite functionality with the radio communication tower 25 and the communication system 100.

The radio communication tower 25 may comprise a wired or wireless protocol as described herein below and/or any known point-to-multi-point wireless communications protocol and platform including cellular, e.g., 3G and 4G, and broadband wireless systems including, e.g., WiMax technologies, and may communicate over a wide spectrum of radio frequencies. One skilled in the art will readily appreciate that the disclosure described herein may be readily applied to various base-station and communications tower technologies, and is therefore not limited thereby. In one embodiment, the radio communication tower is configured to communicate with the communications satellite 30 using the teaching herein.

The communication satellite 30 may additionally be configured to communicate with the radio communication tower 25 or with elements within the network 20. For certain embodiments of the device 10 the communication satellite may be used to route and handle communicates among devices.

In addition, the mobile device 10 may include one or more applications that the user may operate. Operation may include downloading, installing, turning on, unlocking, activating, or otherwise using the application. The application may comprise at least one of an algorithm, software, computer code, and/or the like, for example, mobile application software. In the alternative, the application may be a website accessible through the world wide web.

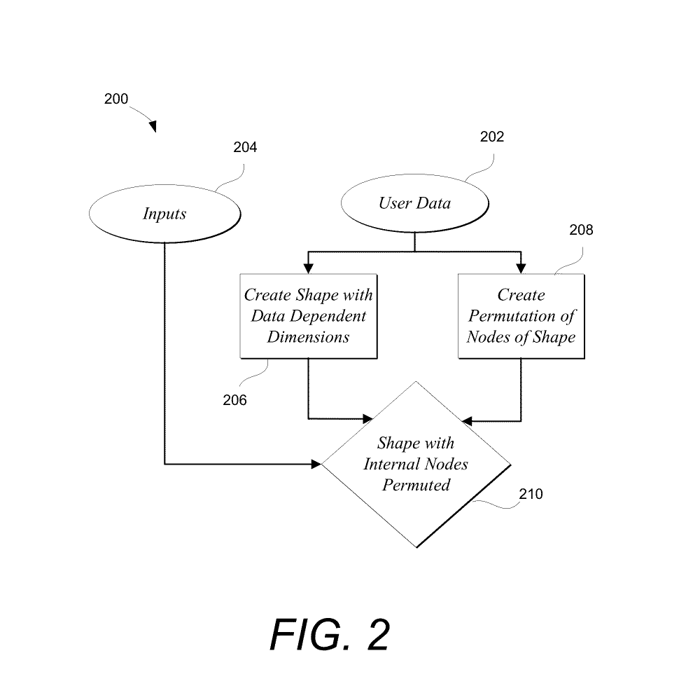

FIG. 2 shows a flowchart illustrating a process 200 for encrypting user data. As FIG. 2 shows, the process 200 includes inputting user data 202 and a variable input 204. The variable input can be a string of alphanumeric characters. The string may be generated randomly or based upon customer usage metrics such as those described herein below, e.g., battery voltage, CPU temperature, data size of the file. In one embodiment, the variable input string is based upon both random generation and a usage metric.

Upon receiving instruction to encrypt a file representing user data, the system generates a shape 206 based upon metrics associated with the file, e.g., file size. In one embodiment, the shape is defined by positions in space using Cartesian coordinates.

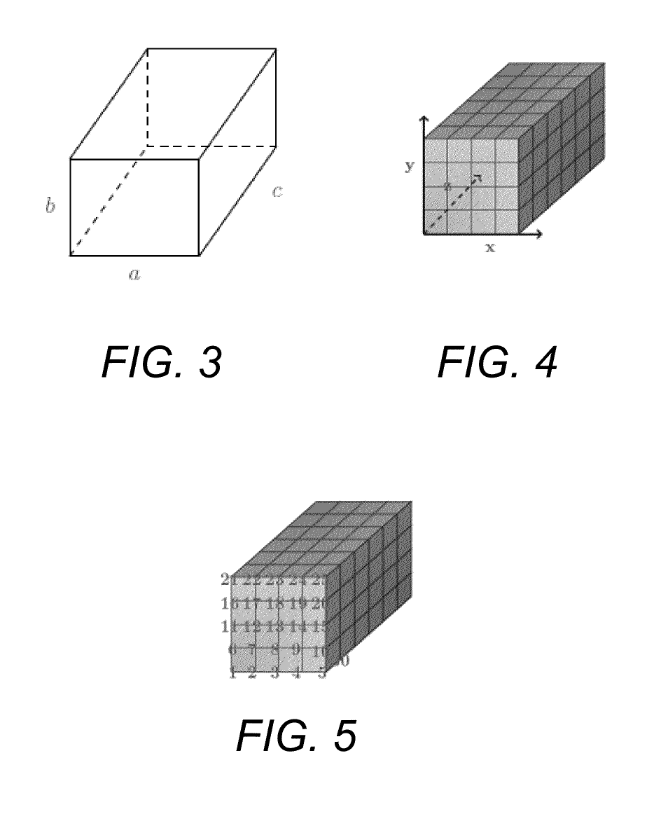

Such a shape is shown as exemplary in FIG. 3. The shape may be three-dimensional. It is understood that many uniform or irregular shapes may be utilized. The dimensions or the shape may be generated randomly or based upon user usage metrics. In one embodiment, the type of shape is randomly selected or randomly generated, e.g., a rectangular shape. In one embodiment, dimensions of the shape, e.g., a, b, and c, must satisfy a condition:

a×b×c≧FileSize [1]

Once we have defined the dimensions of the shape, we can place bits and assign coordinates into 3-dimensional space along and by integer lattice points inside the shape as shown in exemplary FIG. 4. More formally, we will place bits into Cartesian coordinates:

$$\{ ( x , y , z ) \vert \begin{matrix}\begin{matrix}0 \leq x \leq a \\ 0 \leq y \leq b\end{matrix} \\ 0 \leq z \leq c\end{matrix} \} \qquad [ 2 ]$$

Equation 1 checks to determine whether information associated with the user's file will fit into the shape.

In one embodiment, the system may operate based upon storage space efficiency considerations. For example, selecting or using dimension variables a, b, and c so that a×b×c is a predetermined bit or byte size in space from the bit or byte size of FileSize of user's file. Therefore, in one embodiment, accessing parameters p1, p2, . . . pn associated to the user with:

minᵢ≦pᵢ≦maxᵢ, for iε{1,2, . . . ,n} [3]

Equation 3 utilizes dimension vectors in a robust manner to take user data with an arbitrary range of values between some minimum value “min” and some maximum value “max”. Shape dimensions (a, b, c) may then be generated using two user variables p1 and p2 with min1≦p1≦max1 and min2≦p2≦max2. The idea is the following: suppose we have three numbers r1, r2, r3

with 1=r1+r2+r3 where 0<ri<1. Then we can define

a′=(FileSize)̂r1,

b′=(FileSize)̂r2,

c′=(FileSize)̂r3 [4]

wherein:

$$\begin{matrix}{a}^{′} \cdot {b}^{′} \cdot {c}^{′} = ( FileSize ) \hat{} r 1 \cdot ( FileSize ) \hat{} r 2 \cdot ( FileSize ) \hat{} r 3 \\ = ( FileSize ) \hat{} ( r 1 + r 2 + r 3 ) \\ = FileSize\end{matrix} \qquad [ 5 ]$$

It is less desirable working with the exact numbers a′, b′, c′ given above since they are irrational in general. To get an integer, the system will take the smallest integer larger than the values computed above. This is a standard function in mathematics and computer science called the “ceiling”. Given an arbitrary number N we write ┌N┐ for the smallest integer larger than N. For example, ┌3.14┐=4. Hence:

┌a′┐=┌(FileSize)̂r1┐,

┌b′┐=┌(FileSize)̂r2┐,

┌c′┐=┌(FileSize)̂r3┐ [6]

With these definitions the system can ensure that a·b·c≧FileSize, but that this product is not too much larger than the file size. Next, the system uses the secure user parameters p1 and p2 to produce the variables r1, r2, r3 as described herein above. Since mini≦pi≦maxi we have

0≦(pi−mini)≦(maxi−mini) [7]

They system is configured to generate inequalities and not equalities (otherwise dimensions of the shape can be 0). Therefore:

0<(pi−mini)+1<(maxi−mini+2) [8]

We may then represent:

$$0 < \frac{( pi - mini + 1 )}{( maxi - mini + 2 )} < 1 \qquad [ 9 ]$$

Setting:

$$α = \frac{( pi - mini + 1 )}{( maxi - mini + 2 )} \\ and \\ β = \frac{( p 2 - min 2 + 1 )}{( max 2 - min 2 + 2 )} \qquad [ 10 ]$$

So that 0<α<1 and 0<β<1 we can define:

r1=(1−α), r2=α·β, r3=α(1−β)[11]

Consequently the above may be express as:

r1+r2+r3=(1−α)+α·β+α(1−β) [12]

Given user defined parameters p1 and p2 with min1≦p1≦max1 and min2≦p2≦max2 the system may define shape dimensions as:

a==┌(FileSize)̂(1−α)┐

b==┌(FileSize)̂(α·β)┐

c==┌(FileSize)̂α(1−β)┐ [13]

wherein

$$α = \frac{( p 1 - min 1 + 1 )}{( max 1 - min 1 + 2 )} \\ and \\ β = \frac{( p 2 - min 2 + 1 )}{( max 2 - min 2 + 2 )} \qquad [ 14 ]$$

which may be expressed as:

$$\begin{matrix}a = ⌈ ( FileSize ) \hat{} ( \frac{max 1 - p 1 + 1}{max 1 - min 1 + 2} ) ⌉ , & [ 15 ] \\ b = ⌈ ( FileSize ) \hat{} ( \frac{( p 1 - min 1 + 1 )}{( max 1 - min 1 + 2 )} \cdot \frac{( p 2 - min 2 + 1 )}{( max 2 - min 2 + 2 )} ) ⌉ , \\ c = ⌈ ( FileSize ) \hat{} ( \frac{( p 1 - min 1 + 1 )}{( max 1 - min 1 + 2 )} \cdot \frac{( max 2 - p 2 + 2 )}{( max 2 - min 2 + 2 )} ) ⌉ , & \end{matrix}$$

The above equations may be utilized to enumerate coordinates inside a shape using the lexicographic ordering (or dictionary order), in one embodiment. That is (x, y, z)≦(x′, y′, z′) if x≦x′, or x=x′ and y≦y′, or x=x′, y=y′ and z≦z′. This ordering allows the system to enumerate integer coordinates inside of the shape. This idea is schematically illustrated in FIG. 5. Given an arbitrary coordinate (x, y, z) inside the shape, let us write P(x, y, z) for the enumeration of the node (x, y, z). For a shape with dimensions a×b×c we can determine the enumeration of the point at coordinate (x, y, z) via the following formula.

P(x,y,z)=z·a·b+a·y+x [16]

Note P defines a mapping {1, 2, . . . , N}→(integer coordinate of B). Given a number n between 1 and N, the Cartesian coordinate of the node is enumerated n given by inverting the mapping P. For a shape with dimensions a×b×c we can define the inverse mapping P−1:(integer coordinate of B)→{1, 2, . . . , N} by:

$$p - 1 ( x , y , z ) := ( n mod a , \frac{n - x}{a} mod b , \frac{n - x - a y}{ab} ) \qquad [ 17 ]$$

Referring back to FIG. 2, the system 100 may construct a permutation of the nodes inside the shape 208. As there are N=a·b·c nodes inside the shape, the system will construct a permutation of the N nodes using a Knuth shuffle.

From the user data extract for each integer i with 1≦i≦N an integer jsubi such that i≦jsubi≦N. The collection consisting of all pairs (i, jsubi) for 1≦i≦N will serve as a secure key. For optimal security, the choice of the integer jsubi from i should be random. This will ensure that it is equally probable for any permutation to result from the procedure described below.

Suppose we are now given the set of ordered pairs (i, jsubi) with 1≦i≦N and i≦jsubi≦N. The system may construct a permutation a of the nodes inside the shape as follows. Starting with the node in position 1, swap this node with the node in position j1, then swap the node in position 2 with the node in position j2, and so on. If the user data allows us to make a choice of jsubi from i in such a way that any value between i and N is equally likely, then the procedure described above will produce a uniform distribution over all possible permutations.

Note that since the number of possible permutations is N!=N(N−1) . . . 1 the size of the universe for the key space is very large, providing high theoretical security. Another remark is that this section will work for any shape. Once we have enumerated the integer lattice points inside the shape we can permute the entries using a permutation constructed in this way.

Another embodiment of the current disclosure utilizes random number generation for permutation construction. In this way, the system may construct from the user data and extract for each integer i with 1≦i≦N an integer jsubi such that i≦jsubi≦N. The collection consisting of all pairs (i, jsubi) for 1≦i≦N will serve as a secure key.

A sequence of parameters p1, p2, . . . psubn associated to the user may be expressed as:

mini≦pi≦maxi, for iε{1,2, . . . ,n} [18]

For any value of M we can use a given user variable to get a number between 0 and M since:

$$0 \leq \frac{pi - mini}{maxi - mini} M \leq M \qquad [ 19 ]$$

To reduce to only integer values the system utilizes the “floor” or “ceiling” function:

$$0 \leq ⌊ \frac{pi - mini}{maxi - mini} M — ⌋ \leq M \qquad [ 20 ]$$

Equation 20 utilizes a floor function └n┘ which produces the largest integer smaller than n.

In one embodiment, the system constructs a family of integers between some positive integer i and N. Such an integer is given by setting M=(N−i) and adding i in equation 20 as:

$$i \leq ⌊ \frac{pi - mini}{maxi - mini} ( N - i ) — ⌋ + i \leq ( N - i ) + i = N \qquad [ 21 ]$$

In particular, for each integer i between 1 and N we have a key variable ji with ji given by:

$$Ji := ⌊ \frac{pi - mini}{maxi - mini} ( N - i ) — ⌋ + i \qquad [ 22 ]$$

Now we can place the user's file or data into the shape as follows. Suppose the file is written as a bit stream x1x2 . . . xFileSize, where each xn is a bit. We place the bit xi at the Cartesian coordinate enumerated σ(i), where σ(i) denotes the image of the coordinate enumerated by i after applying the permutation σ.

More explicitly, the formula determining the coordinate placement of the bit xi is:

xi→P̂(−1)(σ(i)) [23]

Referring back to FIG. 2, the generated shape is then complete with internal nodes permuted and encrypted using the inputs 210.

Generalizing into any 3-dimensional shape, the system uses the integer coordinates inside of the shape to place data. In one embodiment, the system utilizes lexicorgraphic ordering of coordinates to enumerate the positions inside of the shape. In one embodiment, the system permutes coordinates inside the shape. In one embodiment, the system ensures that there are at least FileSize many integer coordinates inside of the shape.

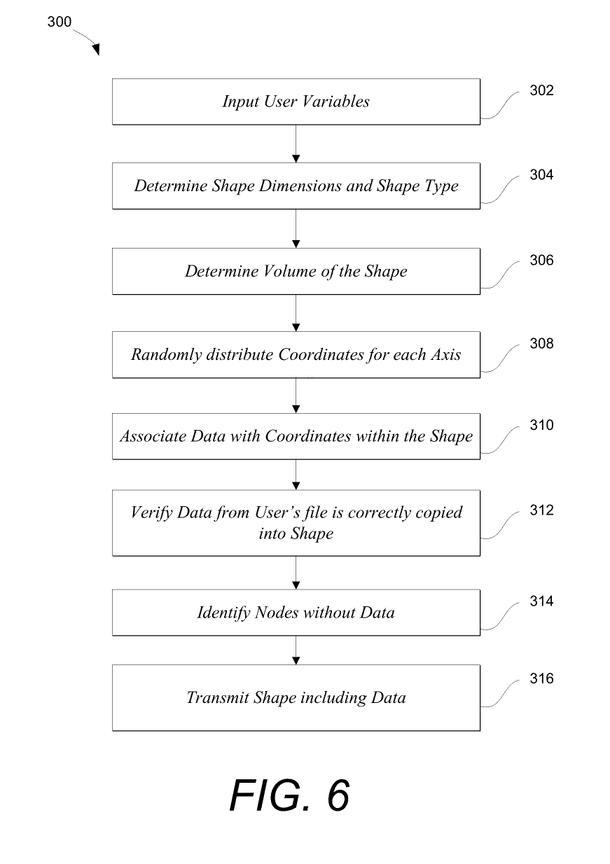

FIG. 6 shows an exemplary process 300 utilizing the techniques discussed herein above for copying a user's file for subsequent transmission. As FIG. 6 shows, at step 302, the system may input user variables, type of shape and dimensions of the shape. In one embodiment, the system can create or use any 3-dimensional geometric shape. In one embodiment, it is either a regular shape (uniform or where the sides/edges are equal). In one embodiment, the shape is an irregular shape (different or non-uniform edges to morph the shape). If the shape forms an irregular shape, in one embodiment, certain random variables are generated or unique user usage metrics or characteristics can be used to calculate the dimensions of the irregular shape. The random variables and usage metrics functions as a form of encryption in the system. Usage metrics can be utilized to identify random or near random bits that may be then used to determine the dimension. For example, if a usage metric of time-last-read is utilized, the numbers of the time may be used to determine the dimension of a first axis, e.g., sum of each individual number.

The shape and dimensions may be randomly generated and/or generated based upon predetermined user-based variables described herein below such as temperature of the CPU, file size of the data, type of data, time of day, etc. In this way, the shape and dimensions of the shape may be additionally random. At step 304, the system determines the shape dimensions and the type of shape. At step 306, the system determines a volume of the shape. In one embodiment, a volume of the shape is greater than the file size. Preferably, the shape's volume is close to the file size. If the file is too large, it wastes space and if it's too small the shape will not be able to contain the file.

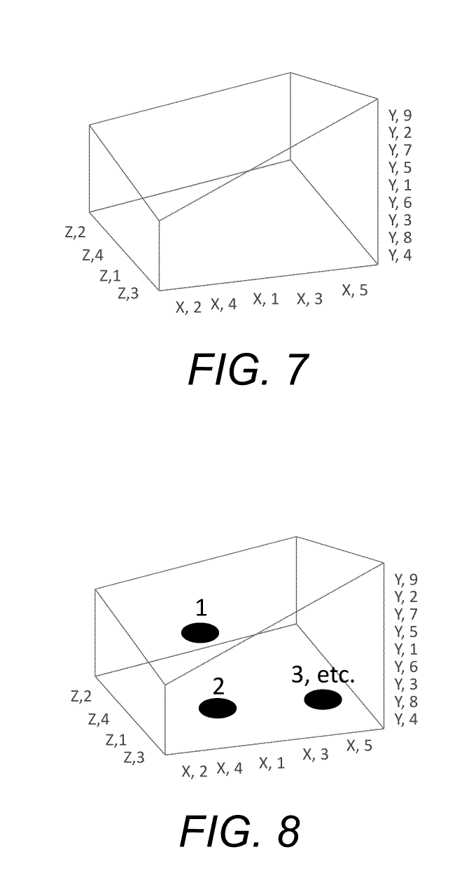

At step 308, the system randomly shuffles coordinates on each axis. An exemplary random shuffle or random distribution is shown in FIG. 7. For example, instead of coordinates X1, X2, X3, X4, X5, etc. the system will generate X3 as the first X position, X5 as the second, X1 as the third, etc. These are done for all coordinates. This randomizes the placement of data in the system. The first piece of data is put at X1, Y1, Z1 but that can be any coordinate location in the shape. This is done through random number generation or by using customer usage metric data.

At step 310, the system associates data with coordinates within the shape. The data may be associated in byte form. FIG. 8 shows an exemplary embodiment of data associated with locations, i.e., nodes, within the shape. In one embodiment, one piece of user data (of any type: byte, bit, binary, etc.) is placed in space inside the 3-dimensional geometric shape. This is done in any number of ways including generating X, Y, Z coordinates or triangulating the position of the data using 3 or more points of the shape. In another embodiment, calculating the placement of the first piece of data is either done by random or certain user usage characteristics are used to determine the values to place the data. This placement may be executed based upon predetermined locations or determined by other means. This is the second layer of encryption, where the first piece of data that must be “retrieved” out of the shape.

Subsequent pieces of data are placed in the shape either anywhere in the shape or each piece of data is placed adjacent to the previous piece of data. It will use an algorithm, pattern or otherwise to “place” the next piece of data. For example, in two dimensions, every cell has 8 closest neighbors (e.g., “king moves” in chess). 3 bits can specify the “next adjacent location”. This in turn could be encrypted. To specify the equivalent of 3-dimensional “king neighbors” would take 5 bits. Depending on the shape, different strategies would be appropriate. In one embodiment, an executed pattern includes sequential associating of data to locations. In one embodiment, associating of data to locations is executed randomly. In one embodiment, associating of data to locations is executed using a predetermined pattern, e.g., x1, y1, z1, x2, y2, z2, etc. until all information corresponding to the user's file is associated with locations within the generated shape.

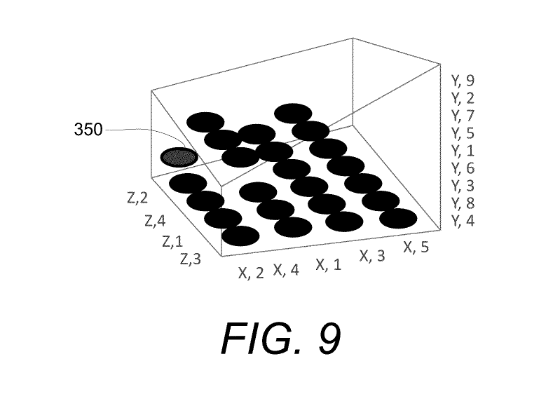

At step 312, the system verifies that each piece of data from a user's file physically resides in the shape. At step 314 the system identifies which nodes within the shape are associated with empty sets, e.g., no data. FIG. 9 shows an exemplary shape of data associated with nodes within the shape wherein an empty or null node 350 is included. At step 316, the system transmits the data. In one embodiment, the system uses resonant vortational division multiplex modulation such as disclosed in U.S. Pat. No. 8,570,923.

In one embodiment, a client (or receiver of the encrypted information) will be able to “reassemble” the data with these steps:

The client knows what kind of shape and its dimensions by having that predetermined during the encryption or an algorithm that will reconstruct the shape. If the shape is an irregular shape, it will use an algorithm or have the keys to reconstruct the shape. Another embodiment generates these keys by certain customer usage information about the computing session.

In one embodiment, the location of the first piece of data is found/retrieved by the use of an algorithm or it is known to the client prior to encryption. Another embodiment is the use of keys to locate the first piece of data. Another embodiment is these keys are generated by certain customer usage information about the computing session.

All subsequent data is found by the use of an algorithm generated by the system where the previous piece of data is adjacent to next piece of data in a 3-dimensional environment. In a 3-dimensional environment, the next piece of data can be in one of 26 positions. One embodiment is the algorithm is known during encryption, another that it is public knowledge, another where a specific algorithm is developed based on variables of values of the customer usage in the computing session.

Examples of customer usage data and user usage characteristics, i.e., metrics that may be used as input variables for generating algorithms or data placement techniques as described herein above: (1) Write to the cloud key code, e.g., one-time code; (2) Time of the last write interaction on the client; (3) Date of the last write on the client; (4) Size of the data of the last write; (5) File path of the last write; (6) Frequency of the last writes in the previous session; (7) Total size of data write in the previous session; (8) Read from the cloud key code, e.g., one-time code; (9) Time on the client of the last read interaction; (10) Date of the last read on the client; (11) Size of the data of the last read; (12) File path of the last read; (13) Frequency of reads in the previous session; (14) Total size of the data read in the previous session; (15) Session Authentication codes, e.g., one-time user session; (16) Time session started on the client; (17) Time session ended on the client; (18) Date the previous session started; (19) GPS location of the last session; (20) Phone number; (21) Total data size of files read and written; (22) Number of times files were read or written; (23) IMEI of the mobile device; (24) Path of the last file read; (25) Path of the first file written; (26) Global User ID that is generated by the system; and (27) PIN that was used when the user registered.

In one embodiment, the system uses certain data variables associated with the user related to the encryption, e.g., a size of the encrypted file, time it was encrypted or decrypted, or any similar variable like listed above but tied to the encryption/decryption process.

It is contemplated that a mobile or other computing device may be configured using a scripting language/API to enable a user to save data remotely using this system to store, modify and access data.

It is contemplated that the teachings herein may be applied to user's data having been previously compressed prior to employing this 3-dimensional shape encryption methodology.

Another embodiment is a database system where the physical 3-dimensional shape is stored in that format in a specially designed 3-dimensional shape structure. It is different from a theoretical approach of creating the geometric shape using existing data base technology. Further, in another embodiment, the physical 3-dimensional shape is transmitted to and from the user/client and the cloud or satellites systems containing servers.

In one embodiment, the keys to decrypt the data are kept solely on the client so no one can access the information by getting the keys from the server or anywhere else.

In one embodiment, a plurality of user's are each assigned a unique shape for storing and/or transmitting.

In one embodiment, the shapes will be relational or the next shape will be formed from certain areas of the previously generated shape.

The disclosure has described certain preferred embodiments and modifications thereto. Further modifications and alterations may occur to others upon reading and understanding the specification. Therefore, it is intended that the disclosure not be limited to the particular embodiment(s) disclosed, but that the disclosure will include all embodiments falling within the scope of the appended claims.

1. Method for encrypting information utilizing three-dimensional shapes, the method comprising:
receiving one or more computer device usage metrics, one or more user files having information, and instructions for encrypting the one or more user files;
selecting shape type from a plurality of predetermined shape types;
determining shape dimensions and shape volume based upon quantity of information associated with the one or more user files;
generating a shape based upon the selected shape type, the shape dimensions, and the shape volume;
distributing axis coordinates for each axis, wherein a node is define at least by axis coordinates within the generated shape;
associating information of the one or more user files nodes within the generated shape; and
transmitting generated shape and data based upon the associating.

2. The method of claim 1, wherein the one or more computer device usage metrics comprise one of a location coordinates corresponding to a last session and a time associated with a login.

3. The method of claim 1, wherein the predetermined shape types comprise a regular shape type and an irregular shape type.

4. The method of claim, 1, wherein the distributing axis coordinates for each axis comprises randomly shuffling each integer axis point.

5. The method of claim 1, further comprising:
associating a first group of the information with a first node selected randomly.

6. The method of claim 5, wherein subsequent groups of the information are associated with nodes according to a predetermined pattern.

7. The method of claim 1, further comprising:
associating a first group of information with a first node, wherein the first node is selected from all nodes of the generated shape based upon the usage metrics.

8. The method of claim 1, wherein the transmitting generated shape and data based upon the associating is executed using resonant vortational division multiplex modulation.

9. The method of claim 1, further comprising:
verifying the generated shape is large enough to associate with all the information.

10. The method of claim 1, further comprising:
decrypting the information on a receiving computing device using an encryption key having information corresponding to a type of shape, dimensions of the generated shape, a pattern associated with a distribution of information and nodes of the generated shape.

11. The method of claim 1, further comprising:
marking nodes having null information.

12. The method of claim 1, further comprising:
verifying all information is associated with the generated shape.

13. Method for encrypting information utilizing three-dimensional shapes, the method comprising:
receiving one or more user files having information, and instructions for encrypting the one or more user files;
selecting one shape type from a regular shape type and an irregular shape type;
determining shape dimensions and shape volume based upon quantity of information associated with the one or more user files;
generating a shape based upon the selected shape type, the shape dimensions, and the shape volume;
verifying the generated shape is large enough to associate with all the information;
distributing axis coordinates for each axis randomly;
generating available nodes within the generated shape using a Knuth shuffle, wherein each node is define using axis coordinates;
associating information of the one or more user files with axis coordinates within the generated shape; and
transmitting generated shape and data based upon the associating.

14. The method of claim 1, further comprising:
associating a first group of the information with a first node selected randomly; and
associating subsequent groups of the information with nodes according to a predetermined pattern.

15. The method of claim 1, further comprising:
associating a first group of information with a first node, wherein the first node is selected from all nodes of the generated shape based upon the usage metrics.

16. The method of claim 1, wherein the transmitting generated shape and data based upon the associating is executed using resonant vortational division multiplex modulation.

17. The method of claim 1, further comprising:
decrypting the information on a receiving computing device using an encryption key having information corresponding to a type of shape, dimensions of the generated shape, a pattern associated with a distribution of information and nodes of the generated shape.

18. The method of claim 1, further comprising:
marking nodes having null information.

19. The method of claim 1, further comprising:
verifying all information of the one or more user files is associated with the generated shape.

20. Method for encrypting information utilizing multi-dimensional shapes, the method comprising:
receiving one or more user files having information, and instructions for encrypting the one or more user files;
selecting one shape type from a regular shape type and an irregular shape type;
determining shape dimensions and shape volume based upon quantity of information associated with the one or more user files;
generating a shape based upon the selected shape type, the shape dimensions, and the shape volume;
verifying the generated shape is large enough to associate with all the information;
distributing axis coordinates for each axis randomly, wherein a node is define at least by axis coordinates within the generated shape and wherein permutation of each of the nodes are generated using a Knuth shuffle;
associating information of the one or more user files with axis coordinates within the generated shape according to a predetermined pattern, the predetermined pattern being defined in a key;
marking nodes having null information;
verifying all information of the one or more user files is associated with the generated shape; and
transmitting generated shape and data based upon the associating, wherein the transmitting is executed from a processor to a non-transitory memory.
